(19) United States
(12) Patent Application Publication
(10) Pub. No.: US 2026/0369027 A1
(43) Pub. Date: Nov. 19, 2026

(54) IMAGE-BASED SPATIAL BUILDING ASSET MAPPING

(71) Applicant: Honeywell International Inc., Charlotte, NC (US)

(72) Inventors: Nagarjuna Reddy Chevuru, Bangalore (IN); Mamata Lohar, Lanja (IN); Manish Karlekar, Bangalore (IN)

(21) Appl. No.: 19/255,298

(22) Filed: Jun. 30, 2025

(30) Foreign Application Priority Data
May 13, 2025 (IN) 202511046029

(51) Int. Cl. G06V 10/426; G06T 3/40; G06V 20/70; G06V 30/19

(52) U.S. Cl. CPC G06V 10/426; G06T 3/40; G06V 20/70; G06V 30/19093

(57) ABSTRACT

An example method for image-based spatial mapping of building assets in building management systems comprises receiving building graphics data and extracting graphical elements from the building graphics data by: performing symbol detection using a computer vision algorithm trained to identify building asset symbols in the building graphics data; extracting text from the building graphics data using optical character recognition; identifying connections in the building graphics data; generating a graph showing spatial relationships between building assets associated with the extracted graphical information. The method further comprises generating contextual embeddings associated with the building assets in the graph; mapping the contextual embeddings associated with the building assets in the graph to a master database of standardized building assets; and generating a spatial asset map of the building assets based on the mapping.

### RELATED APPLICATION

This application claims the benefit of Indian Provisional Application No. 202511046029, filed May 13, 2025, which application is incorporated herein by reference in its entirety.

### TECHNICAL FIELD

The present disclosure relates to systems, devices, and methods for building asset mapping, more specifically to image-based spatial building asset mapping.

### BACKGROUND

Industrial process control and automation systems are often used to automate large and complex industrial processes. These types of systems routinely include sensors, actuators, and controllers. The controllers are often arranged

Industrial process control and automation systems are used to manage large and complex industrial operations. These systems typically include sensors, actuators, and controllers arranged in a hierarchical structure. Lower-level controllers receive measurements from sensors and execute control algorithms to generate signals for actuators. Higher-level controllers perform functions such as planning, scheduling, and optimization. Human operators routinely interact with these controllers and other system components to review warnings, alarms, or notifications and to adjust control parameters or initiate operations (e.g., maintenance) ensuring the process remains within desired limits. If not properly managed, a building-asset issue (such as a failure or malfunction) can escalate into an emergency, crisis, or disaster.

It is also desirable to monitor the health and performance of building assets via building management systems (BMS) to ensure optimal operation, regulatory compliance, and energy efficiency. Modern BMS have evolved to incorporate complex spatial hierarchies and Internet of Things (IoT) technologies, organizing physical spaces from sites and towers down to individual rooms and zones into structured models. Many solutions leverage cloud-based platforms to collect, store, and analyze data from distributed sensors and equipment. By integrating spatial modeling with IoT capabilities, these systems enable more efficient asset tracking, performance monitoring, and predictive maintenance in commercial and industrial facilities.

### SUMMARY

The present disclosure relates generally to systems, devices, and methods for image-based spatial building asset mapping. For instance, the systems, devices, and methods herein can facilitate creating and managing a spatial asset model such as a spatial hierarchical model that is suitable for building management. The systems, devices, and methods herein permit receiving and storing building graphics data (e.g., i.e., spatial data), creating and displaying a spatial asset model based on the building graphics data. Such a display provides a framework for organizing and analyzing building control assets e.g., within a spatial context (e.g., permits users to select and view specific levels within the hierarchy and associated performance data). The systems, devices, and methods herein permit determining attributes of individual building assets and groups of building assets using the spatial asset map. For instance, the systems, devices, and methods herein allow users to interact with the spatial asset map through a display interface, select levels and/or select one or more building assets (i.e., building equipment) and view associated information and performance attributes of thereof. In some instances, the system, devices and methods permit display performance indicators based on actual equipment data associated with one or more specific levels of the spatial hierarchy when the one or more specific levels are selected (e.g., via an input to a display of a computing device, etc.) and/or display performance indicators of one or more building assets responsive to selection of the one or more building assets.

The systems, devices, and methods herein facilitate the definition of spatial asset maps encompassing various levels of spaces, ranging from country, region, and city down to floor plans, rooms, and smaller spatial units. Users can access and modify one or more levels in the hierarchy through an intuitive user interface (UI), enabling seamless management of space types and usage. These defined spaces serve as a framework for mapping assets, facilitating data collection, and conducting analytics within IoT environments. An example, spatial asset map can include a user interface of human machine interface that displays a one or more levels of a hierarchical structure of spaces, starting from “Site” at the top level and including multiple levels (e.g., Site>Tower>Floor>Zone>Room). That is, spatial hierarchies encompass various levels of spaces, ranging from country, region, and city down to floor plans, rooms, and smaller spatial units. As detailed herein, each level within the spatial hierarchy can have corresponding information. For instance, a level or space (e.g., conference room) within the spatial hierarchy can be selected (e.g., via a user input to the UI) and corresponding information (e.g., Name, Space Type, Description, Space Usage Type, Area, Occupancy, and Priority can be displayed). This feature permits readily mapping assets, facilitating data collection, and conducting analytics within IoT environments.

In short, the disclosure principally relates to a user interface providing key features relating to spatial asset maps that allow a user to readily visualize and configure spatial elements within one or more sites, thereby permitting enhanced building management and operations based at least on the use of the spatial hierarchies (e.g., in conjunction with a BMS). For instance, the spatial asset maps herein can be utilized to yield enhanced (e.g., quicker and/or more accurate) building asset issue prediction and hence can lead to improved building asset issue remediation. Moreover, the use of the accurate spatial asset maps formed herein can lead to a reduction in onboarding time for predictive maintenance offerings (e.g., which are configured to identify a future occurrence of a building asset issue and initiate remediation of the building asset issue prior to an actual occurrence of the predicted building asset issue).

That is, accurate asset identification and spatial context are crucial for effective building management. However, current systems often require significant manual intervention to interpret and standardize information from various graphical sources, leading to increased operational costs and potential errors in asset management. For example, while some BMS platforms can efficiently process structured text data using regex and machine learning (ML) transformers, they face significant limitations when handling unstructured or inconsistent text formats—such as those resulting from inadvertent typos or custom notations commonly found in building documentation. Moreover, regular expressions are overly rigid and cannot effectively capture the complexities and variations in asset naming conventions, while large language models often lack the contextual relevance needed for accurate asset identification. Additionally, existing similarity identification techniques using text-based embeddings frequently lead to errors due to their inability to capture spatial relationships and physical context.

To address these and other challenges, the present disclosure provides a system for contextualizing and standardizing image-based data in building management systems through advanced spatial asset mapping techniques. The systems and methods herein can process various image data such as building blueprints (e.g., floor plan images), architectural drawings, piping and instrument diagrams, etc. using computer vision algorithms (e.g., YOLOv5 or a CNN) to detect symbols, extract text, and identify connections between assets. Unlike traditional text-based approaches that rely on regex or language models, this system directly extracts information from these graphical sources using OCR and object detection.

The extracted data is then notably transformed into contextual embeddings that capture both semantic and spatial relationships. The system also includes a standardization engine that matches extracted asset information with a master database, enabling accurate identification even when dealing with unclear text or misspellings. As an example, if a blueprint (e.g., floor plan image) contains a handwritten label like “AHU-01”, OCR would: locate the text block near the Air Handling Unit symbol, recognize the characters “A”, “H”, “U”, “-”, “0”, and “1”, map the characters or one or more embeddings derived from the characters to a known asset type (“Air Handling Unit 01”) in the system's database, even if it's slightly miswritten as AHV-01 due to noise—thanks to contextual and spatial cues, as detailed herein. As such, the approaches herein at least due to the use of graphical information and contextual embeddings (e.g., rather than the raw text data which may contain errors and lack context) derived therefrom enhance building management efficiency by providing precise asset identification, spatial context awareness, and automated updates, all while maintaining data security through on-premises deployment.

At least in view of the above, the system, devices, and methods herein, can mitigate downtime, repair/replacement costs, and/or any impact on tenants or occupants of buildings, as compared to other approaches such as those that rely on text based asset mapping.

As used herein, a building asset issue refers to a malfunction or breakdown of systems or devices that are integral to the operation and maintenance of a building's infrastructure such as those that are monitored by a building management system (BMS). Examples of building asset include heating, ventilation, and air conditioning (HVAC) systems (e.g., including cooling towers, chillers, etc.), lighting systems, security and surveillance systems, fire safety systems, plumbing and water systems, energy management systems, and transportation systems (e.g., escalators, elevators, etc.), among others. Examples of building asset issues include an HVAC failure such as when a heating or cooling system stops functioning, resulting in uncomfortable or unsafe temperature conditions, an electrical failure such as when a power supply to lighting or security systems is interrupted, a sensor malfunction such as when a temperature, humidity, and/or occupancy sensors may fail to provide accurate data (e.g., leading to improper system responses), and/or an energy equipment failure such as a failure of a solar panels or energy storage system (e.g., leading to inefficient energy use). However, embodiments of the present disclosure are not limited to these examples. The building asset issues may occur at a site. For instance, a site can be a single building or facility, a plurality (e.g., group) of buildings, an area (e.g., room(s), space(s), zone(s), etc.) within a building or facility, or a campus of an organization. Embodiments of the present disclosure are not limited to these examples.

A particular example of the present disclosure includes an illustrative method for image-based spatial mapping of building assets in building management systems, the method comprising: receiving building graphics data; extracting graphical elements from the building graphics data by: performing symbol detection using a computer vision algorithm trained to identify building asset symbols in the building graphics data; extracting text from the building graphics data using optical character recognition; identifying connections in the building graphics data; and generating a graph showing spatial relationships between building assets associated with the extracted graphical information; generating contextual embeddings associated with the building assets in the graph; mapping the contextual embeddings associated with the building assets in the graph to a master database of standardized building assets; and generating a spatial asset map of the building assets based on the mapping

Another example of the present disclosure includes a computing device for image-based spatial mapping of building assets in building management systems, the computing device comprising: a display; a memory; and a processor configured to execute executable non-transitory computer readable instructions stored in the memory to: receive building graphics data indicative of building asset locations within an industrial process; extract graphical elements from the building graphics data by: performing symbol detection using a computer vision algorithm trained to identify building asset symbols in the building graphics data; extracting text from the building graphics data using optical character recognition; identifying connections in the building graphics data; and generate a graph showing spatial relationships between building assets associated with the extracted graphical information; generate contextual embeddings associated with the building assets in the graph; map the contextual embeddings associated with the building assets in the graph to a master database of standardized building assets; generate a spatial asset map of the building assets based on the mapping; and display the spatial asset map through a user interface.

Another example of the present disclosure includes a non-transitory, computer-readable medium including instructions that when executed by a processor cause the processor to: receive building graphics data indicative of building asset locations within an industrial process, wherein the building graphics data comprises building blueprints, architectural drawings, piping and instrument diagrams, or any combination thereof; extract graphical elements from the building graphics data by: perform symbol detection using a computer vision algorithm trained to identify building asset symbols in the building graphics data; extract text from the building graphics data using optical character recognition; identify connections in the building graphics data; and generate a graph showing spatial relationships between building assets associated with the extracted graphical information; generate contextual embeddings associated with the building assets in the graph; map the contextual embeddings associated with the building assets in the graph to a master database of standardized building assets; generate a spatial asset map of the building assets based on the mapping; and display the spatial asset map through a user interface.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative industrial process control and automation system;

FIG. 2 is an example computing device for image-based spatial building asset mapping;

FIG. 3A is an example of a portion of a user interface for image-based spatial building asset mapping;

FIG. 3B is an example of a portion of a user interface for image-based spatial building asset mapping;

FIG. 3C is an example of a portion of a user interface for image-based spatial building asset mapping;

FIG. 3D is an example of a portion of a user interface for displaying a graph suitable for image-based spatial building asset mapping;

FIG. 3E is an example of a portion of a user interface for displaying a spatial asset map for image-based spatial building asset mapping; and

FIG. 4 is a flow diagram showing an illustrative method for image-based spatial building asset mapping.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which similar elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

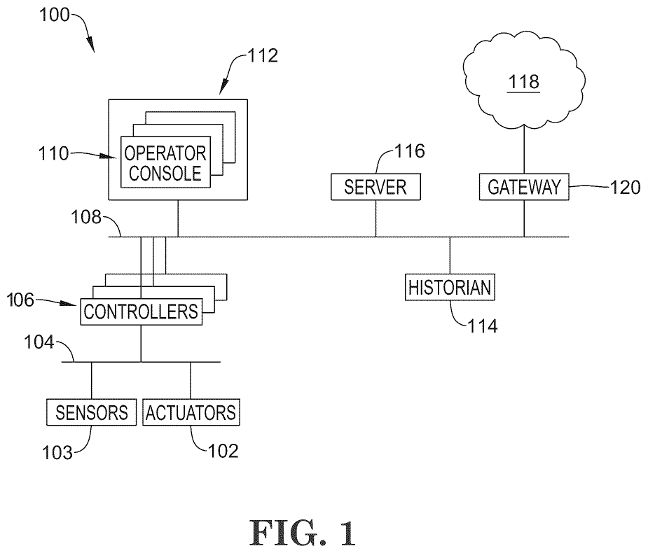

FIG. 1 provides a schematic block diagram showing an illustrative industrial process control and automation system 100. The system 100 includes various components that facilitate production or processing of at least one product or other material. For instance, the system 100 can be used to facilitate control over components in one or multiple industrial plants. The industrial plants may be one or more processing facilities (or one or more portions thereof), such as one or more manufacturing facilities for producing at least one product or other material. In general, the industrial plants may implement one or more industrial processes and can individually or collectively be referred to as a process system. A process system generally represents any system or portion thereof configured to process one or more products or other materials in some manner.

The system 100 includes one or more sensors 103 and one or more actuators 102. The sensors 103 and the actuators 102 represent components in a process system that may perform any of a wide variety of functions. In certain embodiments, sensors 103 and actuators 102 can correspond to equipment that is controlled by the automation system. That is, the sensors 103 and actuators 102 represent components in the industrial plant that perform any of a wide variety of functions. For example, sensors and actuators can measure various characteristics of the process system as well as alter any number of characteristics in the process system of the industrial plant represented by the system 100. The sensors 103 and actuators 102 can be automatically controlled by the process system of the industrial plant (e.g., to permit autocorrection of building asset issues, as detailed herein), manually controlled, or a combination thereof. The control and manipulation of the sensors 103 by the personnel or the process system of the industrial plant, or the combination thereof can be recorded by the historian 114, discussed in further detail below. For example, each time the sensors 103 and actuators 102 are adjusted, a record is created within the historian. The sensors 103 may measure a wide variety of characteristics in the process system, such as but not limited to temperature, pressure, flow rate, chemical concentrations, or a voltage transmitted through an electrical conductor. The actuators 102 may represent devices that are configured to alter a wide variety of characteristics in the process system. As an example, the actuators 102 may open or close one or more valves, or increase or decrease a process set point or the like. At any rate, each sensor 103 may include any suitable structure for measuring one or more characteristics in a process system. Each actuator 102 may include any suitable structure for operating on or affecting one or more conditions of a process system.

In the example shown, a network 104 is coupled to the sensors 103 and the actuators 102. The network 104 facilitates interaction with the sensors 103 and the actuator 102. For example, the network 104 may transmit measurement data from the sensors 103 and/or may provide control signals to the actuator 102. The network 104 may represent any suitable network or combination of networks. As particular examples, the network 104 could represent at least one Ethernet network (such as one supporting a FOUNDATION FIELDBUS protocol), electrical signal network (such as a HART network), Ethernet network, pneumatic control signal network, or any other or additional type(s) of network(s), or any other type of communication path.

The illustrative system 100 also includes various controllers 106. The controllers 106 may, for example, be used in the system 100 to perform various functions in order to control one or more industrial processes. To illustrate, a first set of controllers 106 may use measurements from one or more of the sensors 103 to control the operation of one or more of the actuators 102. A controller 18 may receive measurement data from one or more sensors 103 and use the measurement data to generate control signals for one or more actuators 102. A second set of controllers 106 may be used to optimize the control logic or other operations performed by the first set of controllers. A third set of controllers, 106, could be used to perform additional functions. The controllers 106 could therefore support a combination of approaches, such as regulatory control, advanced regulatory control, supervisory control, and advanced process control.

Each of the controllers 106 may include any suitable structure for controlling one or more aspects of an industrial process. At least some of the controllers 106 may, for example, represent proportional-integral-derivative (PID) controllers or multivariable controllers, such as controllers implementing model predictive control (MPC) or other advanced predictive control (APC). As a particular example, each controller of the controllers 106 may represent a computing device running a real-time operating system, a WINDOWS operating system, or other operating system.

In the illustrative system 100, at least one network 108 couples to the controllers 106 and the other devices in the system 100. The network 108 facilitates communication of information between components. The network 108 may represent any suitable network or combination of networks. For example, the network 108 could represent an Ethernet network or any other suitable communication path.

Operator access to and interaction with the controllers 106 and other components of the system 100 can occur via various operator consoles 110. Each operator console 110 may be used to provide information to an operator and receive information from an operator. For example, each operator console 110 may provide information identifying a current state of an industrial process to the operator, such as values of various process variables and warnings, alarms, or other states associated with the industrial process. Each operator console of the operator consoles 110 may also receive information affecting how the industrial process is controlled, such as by receiving set points or control modes for process variables controlled by the controllers 106 or other information that alters or affects how the controllers 106 control the industrial process. Each operator console 110 may include any suitable structure for displaying information to and interacting with an operator. For example, each operator console 110 may represent a computing device running a WINDOWS operating system or other operating system. In some embodiments, the operator console 110 can be configured to display the user interfaces e.g., dashboards described herein. Alternatively or additionally, the user interfaces e.g., dashboards described herein can be displayed elsewhere, for instance, at a console associated with a supervisor or other personal associated with the industrial plant.

Multiple operator consoles 110 may be grouped together and used in one or more control rooms 112. Each control room 112 may include any number of operator consoles 110 in any suitable arrangement. In some cases, multiple control rooms 112 may be used to control an industrial plant, such as when each control room 112 contains operator consoles 110 used to manage a discrete part of the industrial process/plant.

The illustrative system 100 also includes one or more servers 116. Each server 116 denotes a computing device that executes applications for users of the operator consoles 110 or other applications. The applications could be used to support various functions for the operator consoles 110, the controllers 106, or other components of the system 100. The servers 116 may be located locally or remotely from the illustrative system 100. For instance, the functionality of the server 116 could be implemented in a computing cloud or a remote server communicatively coupled to the system 100 via a gateway such as gateway 120. Each server 116 may represent a computing device running a WINDOWS operating system or other operating system. Note that while shown as being local within the system 100, the functionality of the server 116 may be remote from the system 100. For instance, the functionality of the server 116 may be implemented in a cloud-based server 118 or a remote server communicatively coupled to the system 100 via the gateway 120.

The control and automation system 100 here also includes at least one historian 114. The historian 114 represents a component that stores various information about the system 100. The historian 114 could, for instance, store information that is generated by the various controllers and/or various operators, etc., during the control of one or more industrial processes. The historian 114 includes any suitable structure for storing and facilitating retrieval of information such as a volatile and/or non-volatile memory. Although shown as a single component here, the historian 114 could be located elsewhere in the system 100, or multiple historians could be distributed in different locations in the system 100.

Although FIG. 1 shows one example of the industrial process control and automation system 100, it will be appreciated that various changes may be made. For example, the control and automation system 100 may include any number of sensors, actuators, controllers, servers, networks, operator stations, operator consoles, control rooms, networks, and other components. Also, the makeup and arrangement of the system 100 in FIG. 1 is for illustration only. Components may be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

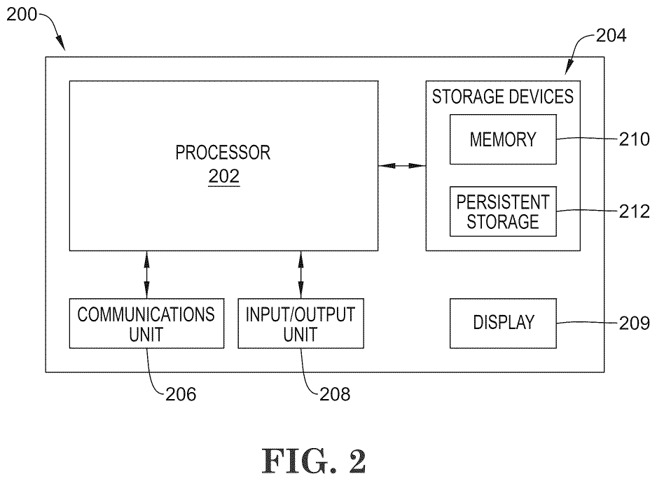

FIG. 2 illustrates an example computing device for image-based spatial building asset mapping. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as collecting information, sorting and analyzing the information as well as generating a report of the analysis, various aspects for image-based spatial building asset mapping, and/or initiating remediation (e.g., initiating an autocorrection and/or manual remediation) of an identified building asset issue, as described herein. For ease of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random-access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display such as a display 209, printer, or other suitable output device.

The display 209 allows at least output of data. In some instances, the display 209 corresponds to a monitor. In some embodiments, the display 209 corresponds to a touch screen display that allows input and output of data.

Although FIG. 2 illustrates an example computing device 200 capable of image-based spatial building asset mapping, changes may be made to FIG. 2. For example, various components in FIG. 2 could be combined, further subdivided, or omitted, and additional components could be added according to particular needs. As a particular example, processor 202 can be divided into multiple processors (e.g., hardware processors), such as one or more central processing units (CPUs) and one or more graphics processing units (GPUs). Also, computing device 200 can come in a wide variety of configurations, and FIG. 2 does not limit this disclosure to any particular computing device or mobile device.

The systems and methods herein provide a comprehensive solution for standardizing and contextualizing image-based graphics data in building management systems through a multi-stage workflow that processes building blueprints (floor plan images, etc.) and architectural drawings to create spatially-aware asset maps. The complete workflow comprises the following stages: i) input acquisition, ii) symbol detection, ii) text extraction, iv) line detection, v) graph construction, and master database mapping.

The system and methods herein begin with the acquisition of building graphics data. The building graphics data can include blueprints, architectural drawings, floor plans, piping and instrument diagrams and/or other graphical representations of building environments. The building graphics data may be provided in various formats including PDF documents, CAD files, scanned images, and/or as digital floor plans, among other possible formats. The building graphics data may be provided from a BMS system (e.g., for a historian) and/or may be provided from another source (e.g., may be input from a system administrator and/or another individual, among other possible sources.

The building graphics data can undergo preprocessing. For instance, the building graphics data can be enhanced, standardized, and/or segmented, among other possible types of preprocessing e.g., such as cleaning or data filtering. For example, image quality of the building graphics data can be enhanced by adjusting brightness, contrast, and/or applying noise reduction algorithms. The building graphics data can be standardized across one or more different types of building graphics data (i.e., multiple graphical formats), for instance, to yield a standardized (i.e., same) resolution for each of a plurality of different types of building graphics data.

Standardizing the resolution of different types of building graphics data can promote various aspects herein such as yielding enhanced symbol, line and text detection, improving computational efficiency, promoting data normalization, and/or ensuring accurate spatial context preservation. For instance, when processing diverse graphical sources such as blueprints, CAD drawings, and scanned documents, standardizing resolution creates consistency for the computer vision algorithms to operate effectively. A standardized resolution ensures these detection models perform with consistent accuracy regardless of the source format, removing the variability that could otherwise lead to detection failures or inconsistencies. Similarly, standardizing resolution directly impacts OCR performance since character recognition accuracy is highly dependent on consistent image quality, variable resolutions from different source materials would otherwise require multiple OCR processing approaches, consistent resolution provides a more reliable baseline for the text extraction and similarity matching algorithms. Further, the system and methods herein ability to accurately identify horizontal and vertical lines that connect assets may be resolution-dependent. Hence, standardized resolution ensures that line thickness is interpreted consistently across different source materials, connection points between assets are accurately identified, and/or the mathematical formulas used for line detection can be optimized for a single resolution standard. Regarding computation efficiency, standardizing resolution optimizes the computational requirements by eliminating the need for multiple resolution-specific processing paths, allowing for consistent memory allocation and buffer sizes, permitting optimization of algorithms for a known resolution parameter, and/or reducing preprocessing overhead for each new document input. Regarding data normalization, standardizing resolution creates a uniform data foundation regardless of whether the source is a high-resolution CAD file or a lower-resolution scanned document, permits consistent feature extraction across formats with inherently different native resolutions, and/or facilitates accurate mapping between extracted graphical elements and the master database. Regarding spatial context preservation, for the graph construction phase spatial relationships must be preserved with high fidelity. Hence, standardized resolution ensures consistent measurement of distances between assets, proportional representation of building spaces regardless of source material, and accurate node placement in the generated graph representation. In view of the above, standardization approach contributes significantly to the system's ability to accurately identify building assets and their relationships across diverse graphical formats, ultimately producing a more reliable spatial asset map.

In some embodiments, for complex, multi-page, or large-scale documents, segmentation techniques divide the input into manageable sections while preserving spatial relationships. Examples of segmentation include spatial area segmentation and document type-specific segmentation. For instance, spatial area segmentation can be employed for large floor plans that exceed memory or processing limitations and/or exceed a threshold. For instance, the systems and methods herein can employ spatial area segmentation to segment large floor plans into individual rooms or zones (as seen in the floor plan examples) while recording boundary connections, can divide large floor plans into a grid of overlapping sections with sufficient overlap to ensure connections between segments are preserved, and/or can process the document at different levels of detail, from building-wide down to individual asset clusters. In some embodiments, the system and methods herein can employ document type segmentation based on a document type. For instance, for blueprints segments based on architectural boundaries (rooms, floors, wings), for P&ID diagram segments based on system boundaries (HVAC systems, electrical systems), and/or for multi-page documents can create logical connections between pages while processing each page individually. In any case spatial relationships can be preserved. For instance, a coordinate system can be employed, boundaries can be annotated, among other possibilities. Hence when represented in a grid, nodes and connections maintain their relative positioning and connection patterns even after being processed separately. An example segmentation workflow includes i) initial document analysis: The system analyzes the full document at low resolution to identify logical segmentation boundaries, i) sequential segment processing: Each segment is processed at full resolution while maintaining reference to its global position, iii) Inter-segment connection identification: The system identifies connections that cross segment boundaries, and iv) hierarchical reassembly: Processed segments are reassembled into a unified spatial asset map. Segmentation allows the system to handle documents of arbitrary complexity and size while maintaining processing efficiency and preserving all spatial relationships between building assets.

The system and methods herein can perform symbol detection to identify building assets represented as graphical elements within the input documents using computer vision algorithms, as detailed herein. As mentioned, the symbol detection process differs from traditional text-based approaches by directly identifying assets from their graphical representations, enabling identification even when textual labels are unclear, misspelled, or missing. For instance, the system and methods herein can collect a comprehensive set of building graphics data containing various asset symbols (e.g., HVAC units, controllers, sensors, valves).

In some embodiments, data annotation can be provided such that symbols within training data are manually annotated to create a labeled dataset for supervised learning. In such instances, the systems and methods herein can acquire and augment building graphics data, annotating the data to identify asset symbols; and training a computer vision algorithm to yield the trained computer vision algorithm. The computer vision model can be a trained You Only Look Once (YOLO) detection model or is a trained convolutional neural network (CNN), among other possibilities. For instance, a YOLO based model such as a YOLOv5 object detection model can be trained using the annotated dataset to identify common building asset symbols to permit subsequent symbol detection as is detailed herein. That is, the trained model can process the input graphics to detect and identify building asset symbols, generating bounding boxes and confidence scores for each detected symbol. In some embodiments, the computer vision model can undergo optimization of the model for accuracy in detecting various equipment types via supervised training and/or via real-world feedback for a user. The computer vision algorithm can be retrained or modified accordingly, for instance, by fine-tuning detection thresholds to minimize false positives and negatives.

In some embodiments, the trained model can provide real-time identification of equipment symbols within floor plans or other types of building documents such as those described herein. The trained model can employ visual pattern recognition to identify assets based on their graphical representation rather than relying solely on text labels, can function effectively even when text is unclear, misspelled, or missing, can recognizes standard equipment symbols across different building documentation formats and can provide spatial context preservation, for instance, by maintaining the exact location and orientation of equipment within the actual floor plan or other type of building document.

After symbol detection, the systems and methods herein can extract textual information associated with the detected symbols. That is, the systems and methods herein can extract text from the building graphics data using optical character recognition. As an example, the systems and methods can extract text such as building asset names e.g., “FPB 20-10”, “VAV 20-25”, etc. For instance, OCR can be applied to the entire document or regions of interest near detected symbols such as those associated with the location of building asset symbols. Text coordinates can undergo extraction such that spatial coordinates (e.g., X and Y coordinates) are recorded for each extracted text element, preserving the positional relationship between text and symbols. In some embodiments, the extracted text can undergo classification into categories (e.g., asset names, point types, technical specifications) based on context and placement. For instance, in some embodiments the systems and methods herein can extracting text coordinates from the recognized text and can associate the extracted text with detected symbols based on spatial proximity between the extracted text and the detected symbols. For example, an extracted symbol that is most proximate to the coordinates of the text can be associated with the text.

In some embodiments, the extracted text or a derivative of the text (e.g., an embedding based on the text) can be automatically corrected, as detailed herein. Hence, the system and methods herein can address various challenges in building documentation such as resolving unclear or low-resolution text through advanced recognition algorithms, non-standard naming conventions through contextual analysis, and can address OCR errors or misspellings through similarity matching techniques as described herein.

The systems and methods herein can perform line detection to identify connections between detected symbols. This line detection can promote establishing the spatial and functional relationships between building assets. For instance, computer vision algorithms identify horizontal and vertical lines in the input graphics using techniques such as the OpenCV line detection algorithm. Coordinates associated with the lines such as the start and ending coordinates of each detected line can also be extracted. The extracted lines can be associated with building symbols based on proximity and intersection analysis. Hence, a comprehensive map of connections between building assets, providing crucial spatial context that text-based approaches cannot capture.

In some embodiments, the systems and methods herein can identify horizontal lines, vertical lines, and other lines (e.g., at other angles) separately. For instance, identifying the horizontal lines and vertical lines separately may reduce a computational burden and/or enhance accuracy of detection of the lines. For instance, in some embodiments, the systems and methods herein utilizes computer vision algorithms specifically designed to identify horizontal and vertical lines in building floor plans, piping an instrument diagrams, etc. In some embodiments, the lines can be detected by standard computer vision techniques based on pixel sequence analysis on XY coordinates.

In some embodiments, the system and methods herein can use the information from symbol detection, text extraction, and line detection to construct a graph-based representation of the building's assets and their relationships. For example, a building asset graph can be include: i) node creation where each detected symbol becomes a node in the graph, with associated extracted text information, ii) text-to-node association where extracted text is linked to the appropriate nodes based on spatial proximity, edge creation where detected lines form edges between nodes, representing physical or functional connections between assets, and spatial context preservation where the graph maintains the relative positioning and connections of assets as represented in the original graphics. The resulting graph serves as an intermediate representation that preserves both the semantic content (asset identities and attributes) and spatial relationships (connections and positioning) from the original building graphics.

The systems and methods can include generating contextual embeddings associated with the building assets in the graph. For instance, once the graph is constructed, the systems and methods herein can transform the extracted information in the graph into contextual embeddings. For instance, for shorter text or individual characters, the system generates character-level embeddings. For longer text segments, the system creates sentence-level embeddings (e.g., Keyword/Sentence-Level Embeddings). The embeddings incorporate information about spatial positioning and connections between assets and can include additional contextual information from the graph structure is incorporated into the embeddings. Hence, the embeddings capture not just the literal content of the extracted information, but also the contextual and spatial relationships between different elements, enabling more accurate matching with standardized asset information.

The systems and methods can include mapping the contextual embeddings associated with the building assets in the graph to a master database of standardized building assets. The mapping process include: i) a similarity calculation where similarity scores are calculated between the generated embeddings and standardized asset information in the master database, ii) threshold-based matching where any matches are identified based on similarity scores exceeding predefined thresholds (e.g., 98%, etc.), iii) ambiguity resolution for cases where multiple potential matches exist, additional contextual information is used to resolve ambiguities, and iv) new entry creation when no suitable match exists in the master database, the systems and methods herein can propose the creation of new standardized entries e.g., by prompting a user to create new entry or at minimum notifying the user that there is an absence of a corresponding element in the master database of standardized building assets. Hence, the mapping methodology herein can handle various challenges such as the presence of misspellings and OCR Errors where similar embeddings can match despite character-level differences (e.g., “aoh” matched to “ahu”), naming convention variations where different naming formats for the same asset type are recognized through embedding similarity, and incomplete information where partial information can still be matched based on available context.

The systems and methods can include generating a spatial asset map of the building assets based on the mapping. For instance, following the mapping process, a comprehensive spatial asset map is generated by performing standardized asset identification where all assets are identified with standardized names and attributes from the master database (e.g., which includes any new mappings provided by a user for one or more components initially identified as not including a mapping in the master database). The spatial map generation can employ spatial relationship preservation where the connections and relative positioning of assets are maintained, a hierarchical Structure where assets are organized into a hierarchical structure reflecting their physical and functional relationships, and user interface integration where the spatial asset map is integrated into the building management system's user interface for interactive visualization. Hence, the raw graphical representations can be transformed into a structured, standardized, and spatially-aware representation of building assets, enabling more efficient building management through improved asset identification, monitoring, and maintenance.

Additionally it is noted that the systems and methods herein can in at least some instances operate securely on-premises, eliminating the need to send sensitive building information to external services, while providing automatic updates whenever new building graphics data becomes available. Such approaches significantly improves upon traditional text-based methods by leveraging the rich spatial and visual information contained in building graphics, resulting in more accurate asset identification and contextual understanding of building systems. Moreover, the systems and methods herein can be configured to provide automated updates when new building graphics data becomes available, ensuring that the spatial asset mapping remains current and accurate as building configurations change.

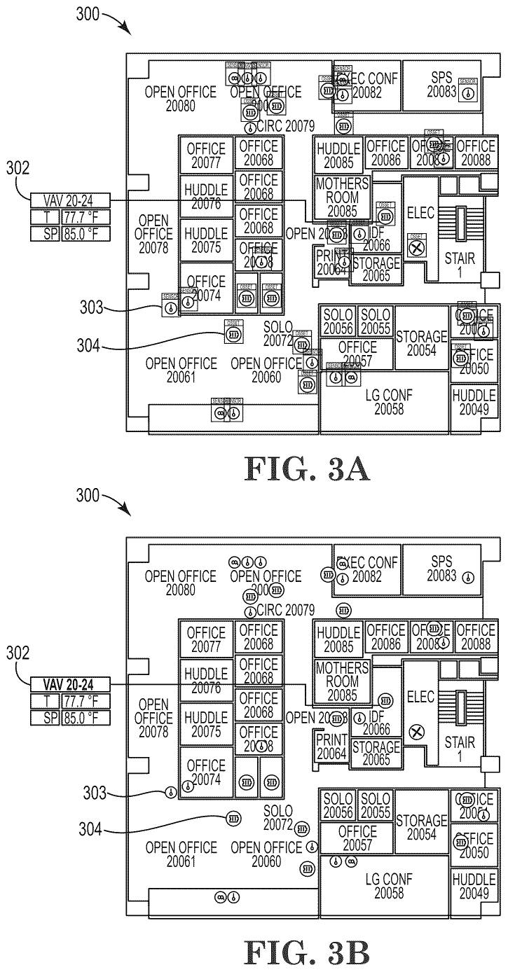

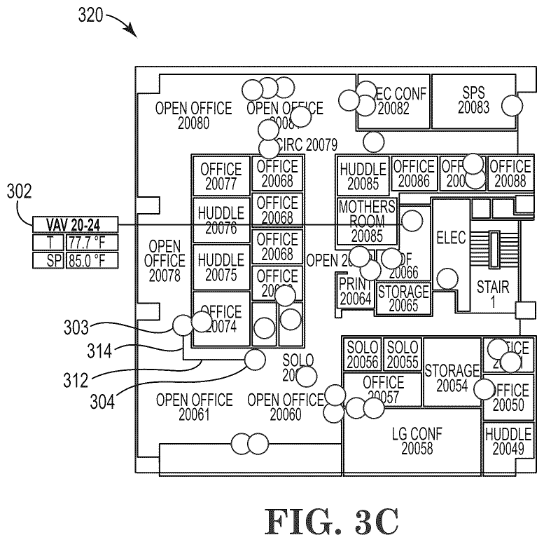

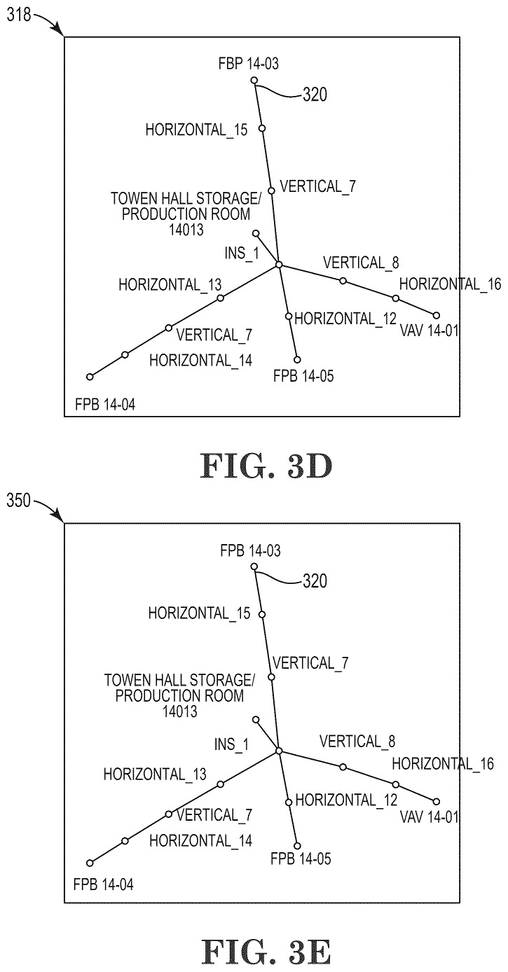

FIGS. 3A-3D illustrate user interfaces associated with an example flow for image-based spatial building asset mapping. The user interfaces in FIGS. 3A-3D can be included in or displayed by a computing device such as the computing device 200. The user interfaces in FIGS. 3A-3D illustrates a portion or all of the building asset and/or other components associated with a site or a portion of a site. The information displayed in the user interface for image-based spatial building asset mapping can correspond to any quantity of buildings (e.g., 1 building) and any quantity of floors, zones, rooms, and/any quantity of building asset therein. While FIGS. 3A-3C are described herein in a given sequence, an order of aspects of image-based spatial building asset mapping e.g., of text detection and line detection can be varied in some instances.

FIG. 3A illustrates an example of symbol detection for image-based spatial building asset mapping, as detailed herein. Specifically, FIG. 3A depicts a floor plan image 300 where various building asset symbols, as detailed herein, have been identified. As illustrated in FIG. 3A, the floor plan image 300 displayed a user interface, represents a two-dimensional representation of a building floor shows the spatial layout of rooms, corridors, and designated areas where various building assets are located. Each of the spaces (e.g., rooms, zones, etc.) in the floor plan image 300 can have a corresponding identifier (e.g., room 1, etc.). Similarly, each of the building asset within the spaces in the floor plan image 300 can have corresponding performance data (e.g., real-time telemetry data) or an indicator thereof displayed in the floor plan image 300. That is, the floor plan image 300 in some embodiments can correspond to a current or real-time floor plan image of a floor or portion of a floor in a given site.

The floor plan image 300 contains symbols representing different types of building assets such as variable air volume boxes (VAVs), field programmable boards (FPBs), and other HVAC components. The building asset is physically located within the space displayed in the user interface such as the floor plan image 300. However, in some embodiments, additional building asset that is physically located outside of the space can also be represented in the floor plan image 300. For instance, an air handling unit of other type of building asset that is located upstream or above the building asset (e.g., a valve or damper) that is actually located in the space can also be represented in the floor plan image (e.g., via arrows, text, etc.) The building asset symbols can be detected by a computer vision algorithm (e.g., YOLOVv5, etc.) which can systematically scan the floor plan and identify building asset symbols within it. Pattern recognition techniques in the computer vision algorithm can readily distinguish equipment symbols from other graphical elements in the floor plan image 300. As illustrated in FIG. 3A, different types of building asset symbols that are detected can be identified.

Once identified, the building asset symbols can have a corresponding visual identifier associated therewith. For instance, asset symbol markers can appear as colored (e.g., red, etc.) symbols (e.g., boxes, circles, etc.) throughout the floor plan image 300. In some embodiments, different types of building assets can have different types of identifiers. For instance, sensors can have an identifier 303 of a first color and building equipment can have an identifier 304 that is a second color which is different than the first color. That is, the building asset identifiers such as the sensor identifiers 303 and the building equipment identifiers 304 can be overlaid or otherwise superimposed on the original floor plan image 300 substantially at a location of building asset corresponding thereto. While specific asset marker symbols 304 are depicted in FIG. 3A, the use of other types of indicators (e.g., shading, text, different symbol, etc.) are possible. In any case, these markers indicate where the computer vision algorithm has successfully identified building asset symbols. Each marker corresponds to a specific piece of building asset, such as an air handling unit, valve, sensor, or controller, allowing the system to create a digital inventory of equipment present in the floor plan image 300 of the particular floor or portion of the particular floor at a site (e.g., in a building). In some embodiments, the computer vision algorithm can be trained to detect whether the given building asset corresponds to an asset (e.g., an HVAC component, etc.) or a sensor associated therewith. In such embodiments, a visual indicator such as text (e.g., “asset” or “sensor”) can be overlaid or otherwise superimposed on the original floor plan image 300 substantially at a location of the building asset that corresponds thereto.

The precise spatial coordinates (e.g., X and Y coordinates) of each identified symbol within the floor plan can be determined during the extraction process. Hence, the systems and methods herein can be configured to maintains the positional context of the symbols (and corresponding building asset), which is crucial for later establishing relationships between text labels and the building assets they describe or are associated with.

A database (i.e., a symbol recognition database)) or other type of storage structure can be maintained which includes reference images and patterns that the computer vision algorithm uses to accurately identify different types of building asset symbols within the floor plan. For instance, the database can indicate whether a given symbol for building asset corresponds to an asset (e.g., an HVAC component, etc.) or a sensor associated therewith. The database is continually updated and refined as the system encounters new symbol variations.

As mentioned, in some embodiments the input data such as the floor plan image 300 can undergo various preprocessing prior to the computer vision algorithm performing symbol recognition. For instance, the floor plan image 300 can undergo resolution standardization to ensure that the images are properly formatted for optimal symbol detection performance.

In some embodiments, the floor plan image 300 can undergo various transformations such as rotation, scaling, brightness adjustments, and controlled noise introduction to expand the diversity of training examples for the computer vision algorithm. These augmentations help the computer vision algorithm more accurately identify symbols regardless of variations in image quality, orientation, or scale. In some embodiments, the user interfaces herein such as the user interface illustrate in FIG. 3A can be configured to permit domain experts (e.g., operators, etc.) to manually label equipment symbols in training images, establishing the reference standard against which the detection model's performance is measured. The framework ensures consistent labeling practices and maintains the quality of the training data.

As an example, the logical flow of information in FIG. 3A can begin with the floor plan image 300 being processed preprocessed (e.g., to a standard resolution). The preprocessed image then undergoes symbol detection by a trained computer vision algorithm. The result of the symbol detection is the identification of equipment symbol in building graphics data (e.g., the floor plan image 300) and the addition of the visual identifiers 304 associated with the identified equipment symbols to the building graphics data.

After symbol detection, an image such as the floor plan image 300 can undergo text detection and extraction for image-based spatial building asset mapping, as detailed herein. The text can be extracted from building graphics data such as the floor plan image 300 using optical character recognition. The extraction, as detailed herein, can identify and extract textual information from the floor plan. For instance, the text elements can extract all text elements such as equipment identifiers (e.g., “VAV 20-24” as indicated at element 302), room numbers (“open office 20061”), and measurement values (e.g., corresponding to telemetry data, etc.) while distinguishing them from graphical symbols and lines.

Text identification markers may be overlaid or otherwise added to the identified text. For instance, identified text may appear as highlighted text elements within the floor plan that have been successfully recognized by the OCR, among other possible types of identifiers. Each marked text element (e.g., text element 302 which is now bolded in FIG. 3B to indicate that the text has been recognized) represents information that has been identified and is ready for extraction, such as equipment labels (e.g., “FPB 20-10”), temperature readings (e.g., “T 77.7 °F”), and carbon dioxide measurements (e.g., “CO2 648 ppm”), among other possible types of text. The precise spatial coordinates (e.g., X and Y coordinates) of each extracted text element within the floor plan can be determined during the extraction process. Hence, the systems and methods herein can be configured to maintains the positional context of the text, which is crucial for later establishing relationships between text labels and the building assets they describe or are associated with.

After symbol detection and text extraction, an image such as the floor plan image 300 can undergo line detection for image-based spatial building asset mapping, as detailed herein. That is, the input for the line detection can be the same floor plan image 300 or other type of building graphics data that has already undergone symbol detection (e.g., as indicated in FIG. 3A) and text detection (e.g., as indicated in FIG. 3B). With continued reference to FIG. 3C, the computer vision algorithm can analyze the floor plan image 300 to identify linear structures such as horizontal line (e.g., horizontal line 312) and vertical lines (e.g., vertical line 314) that represent connections between equipment. Note horizontal and vertical lines 312, 314 are illustrated in FIG. 3C. However, for ease of illustration the other lines between endpoints of the other linear structures have been omitted in FIG. 3C.

Once identified, the linear structures can have a line indicator associated therewith. For instance, the linear structures can be designated with a certain color or highlighting (e.g., white-highlighting), among other possibilities. For each detected linear structure the precise start and end coordinates can be identified. For instance, a start pixel and an end pixel of a sequence of pixels corresponding to a linear structure can be identified as the start and end coordinates of the linear structure. Hence, the length and location of connections between different building assets in the floor plan image 300 can be readily identified. The start and end coordinates of the linear structure are indicated in FIG. 3C as circles, however the start and/or end coordinates may be identified with different identifiers such as different symbols, etc. The detected linear structure (detected horizontal and vertical lines) can be linked with identified symbols to establish connections between the building asset. For instance, a building asset symbol that is most proximate to a start or end pixel of a linear structure can be linked (connected to) the linear structure. In this way, each of the detected linear structures can be linked to one or more corresponding (most proximate) building asset symbols.

The floor plan image 300 after having undergo symbol, text, and line detection can provide a comprehensive map between building assets. For instance, spatial data of how each of the building asset is physically interconnected (e.g., coordinates and interconnections with other building assets) can be determined and stored in a database or otherwise stored. This information can serve as the basis for graph construction, as detailed herein with respect to FIG. 3D. That is, the system and methods herein desirably capture the spatial relationships between assets, providing critical context that purely text-based approaches cannot achieve, and enabling the system to understand not just what assets exist, but how they physically relate to each other within the building environment.

In some embodiments, the systems and methods herein can apply confidence values to extracted or identified elements such as extracted text, identified symbols, and/or identified lines. For instance, when the confidence value for an element is a non-zero value below a threshold value the element may not be identified as a symbol, text, and/or line and/or a notification may be provided to an operator or other individual of the potential presence of a symbol, text, and/or line, (e.g., which can be confirmed or declined by the operator). Conversely, when the confidence value for an element is non-zero value above a threshold, the element may be identified as a symbol, text, and/or line.

After symbol detection, text extraction, and line detection, a graph 318 for image-based spatial building asset mapping can be generated from an image such as the floor plan image 300, as detailed herein. For instance, the graph construction process transforms the information gathered from the previous three stages (e.g., as represented in FIGS. 3A-3C) into a structured graph representation (e.g., a represented in FIG. 3D) that preserves both the identity of building assets and their spatial relationships. With continued reference to FIG. 3D, a node (e.g., node 320) can be created for each detected building asset in the floor plan image 300 or other type of graphical image data. That is, the nodes represent a specific piece of building asset. Each node is located at a corresponding spatial coordinate in the graph 318 that matches with or corresponds to the spatial coordinates in the original floor plan image 300.

The nodes can have extracted text associated therewith. The extracted text can match (e.g., be the same as) the text that is extracted from the floor plan image 300. For instance, equipment identifiers (like “FPB 04-03”) are attached to their corresponding nodes. In some embodiments, certain spaces within the floor plan image such as room identifiers (like “Tower Hall Storage/Production Room”) are processed as special nodes representing these spaces (e.g., rather than building assets). The nodes can be connected based on the detected lines. For instance, horizontal connections (labeled as “horizontal_13”, “horizontal_15”, etc.) are established which correspond to detected horizontal line and similarly vertical connections (labeled as “vertical_7”, “vertical_8”, etc.) are created which correspond to detected vertical lines in the floor plan image 300. That is, the connections between the nodes in the graph 318 accurately represent the physical connections between equipment as shown in the original floor plan 300. Moreover, the relative positioning of assets from the original floor plan is maintained in the graph 318. Hence, the system and methods herein can readily and accurately transform raw graphical data into a structured, machine-readable representation in the form of graph 318 that captures both the identity of building assets and their spatial relationships, enabling more effective building management through improved asset contextualization.

Contextual embedding can be generated from the information in the graph derived from building graphics data. For instance, using the graph 318 created in FIG. 3D as input, the systems and methods herein can generate embeddings that capture: semantic information (e.g., asset identity from node labels), spatial relationships (e.g., connections represented by line or edges like “horizontal_15”), and contextual attributes (e.g., asset type, location, connections). For example, for short text (e.g., “FPB 04-03” character-level embeddings can be created, while for longer descriptions (e.g., “Tower Hall Storage/Production Room”) sentence-level embeddings can be created.

Notably, spatial context can be encoded in the contextual embeddings herein. For instance, horizontal and vertical connections can be encoded in the embeddings and the spatial positioning of each node relative to other nodes can be preserved. Encoding the spatial context into the embeddings can capture a physical layout relationships that are important for various aspects of effective building asset management. The embeddings can be matched or compared to standardized asset information, for instance, using various similarity algorithms. Generally, standard similarity algorithms may compute a cosine similarity (or other distance metric) to quantify or rank pairs of information to determined whether the context embeddings have a match (e.g., with a suitably high similarity score) in the master database.

In some embodiments, non-standard text in the embedding can be automatically corrected using contextual cues, spatial relationships, or a combination thereof, that are included in or derived from one or more of the contextual embeddings. This permits matching even with OCR errors or misspellings (e.g., “aoh” matched to “ahu”) and hence the systems and methods herein can accurately identify building assets despite variations in naming conventions.

The final spatial asset map can be generated based on the embeddings. The final spatial asset map may be similar to the graph 318 e.g., in terms of node and line locations but has standardized, accurate representation of building assets that maintains all the spatial relationships from the original graphics while correcting any naming inconsistencies or errors through the embedding and master database mapping process. That is, graph 318 contains raw extracted data elements like “FPB 04-03” and connections labeled as “horizontal_15” and “vertical_7”. These raw data elements have not yet been standardized through master database mapping, which is a defining characteristic of the final spatial asset map.

The master database serves as a centralized repository of standardized building asset information that is critical to the graphics data contextualization system. The database contains comprehensive information about standard building assets (VAVs, AHUs, FPBs, etc.). The database can store character-level representations (e.g., AHU) and/or full-term standardized names (e.g., air handling unit). In some embodiments, the database can store both character-level representations and full-term standardized names. This two-tier approach enables matching at different granularity levels depending on input quality and/or input type.

That is, for each contextual mapping it can be determined whether a match exists in the master database. When standard text is identified, the systems and methods herein automatically maps to the standardized version in the master database. Stated differently, when a corresponding mapping exists in the master database for a contextual embedding of the contextual embeddings, using the mapping for the building asset in the spatial asset map. However, when non-standard text is identified in an embedding, the systems and methods herein can automatically correct the non-standard text by mapping to the standardized version in the master database and/or prompting an operator or other individual of the presence of non-standard text in the embedding. For instance, in some embodiments the systems and methods herein can prompt a user to update the master database with a new mapping for the embedding without a corresponding mapping and can use the new (user-provided) mapping for the building asset in the spatial asset map. The new mapping can be stored for in the master database for mapping to future use with future embeddings.

In some embodiments, the system and methods herein uses spatial relationships detected from the graphics (connections between assets) to aid in automatically mapping to the correct standardized names. The use of spatial relationships helps resolve ambiguities when text alone is insufficient.

FIG. 3E illustrates an example of a spatial asset map. The final spatial asset map 350 is similar graph 318, but includes the standardizes the asset information (correcting any OCR errors, etc.) generated by mapping the contextual embeddings associated with the building assets in the graph to a master database of standardized building assets. For instance, unlike graph 318 which includes the incorrect text “FBP”. However, the spatial map 350 instead includes that text “FBP” which was derived from matching the incorrect text “FBP” to the correct standardized text “FPB” which corresponds to a field programmable board (FPB) in the master database. Thus, the systems and methods herein can take the initial graph 318 output and transforms it into vector-based contextual embeddings that can be efficiently matched against the master database, enabling accurate identification even when dealing with unclear text, misspellings, or non-standard naming conventions. This approach creates a robust solution in the form of the spatial map 350 that overcomes the limitations of traditional text-based approaches by incorporating spatial awareness and contextual relationships into the asset identification process. This approach at least therefore creates a comprehensive spatial asset representation that can be integrated with building management systems for improved monitoring, maintenance, and operation of building assets.

For instance, the spatial asset map can be displayed through a user interface and can be configured to permit user interaction with mapped building assets in the spatial asset map. The user interface or display can provide options for a user to readily create and/or modify the spatial asset map. For instance, the user interface can be configured with various graphical elements (e.g., Undo, Redo, Add, Copy, Paste, move up, move down, and delete, etc.), permitting users to modify the spatial asset map and/or analyze one or more elements (e.g., building asset), thereby providing seamless management of space types and usage. For example, a user can provide an input via one or more selectable icons or graphical elements that are displayed in the user interface. Selection of such selectable icons or graphical elements can permit a user to readily create or modify aspects of the spatial asset map and/or view detailed information such as a name, a space type, a description, a space usage type, an area or size, an occupancy state (e.g., an actual occupancy state or a designed occupancy state), performance data (e.g., telemetry data), and/or a priority (e.g., low priority, medium priority, high priority, or critical priority). For instance, the display or performance information and/or any notification or warnings associated with building asset in the spatial asset map may assist an individual (e.g., operator) in discerning whether there are any current or potential building asset issues that may need remediation.

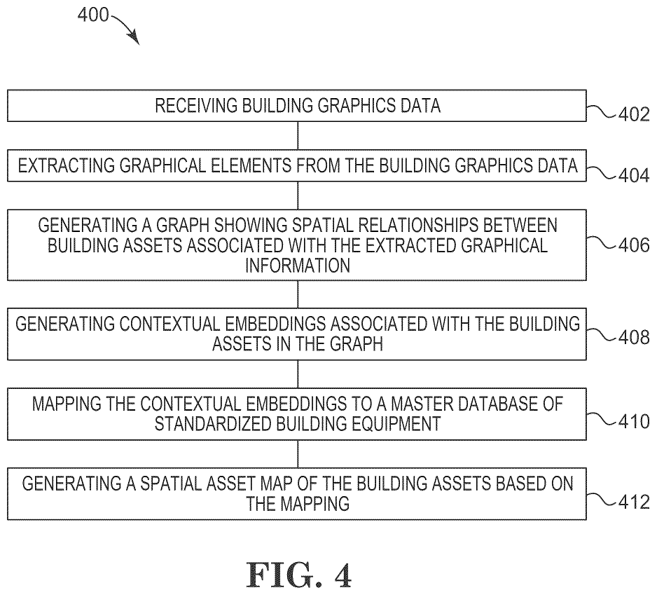

FIG. 4 is a flow diagram showing an illustrative method 400 for image-based spatial building asset mapping. At 402, the method 400 includes receiving, by a computing device (e.g., computing device 200 as described with respect to FIG. 2) of a building management system, building graphics data, as detailed herein. The building graphics data can be indicative of building asset locations (e.g., building equipment locations) within an industrial process. Such data can be received continuously, periodically (e.g., each minute, each hour, etc.), and/or can be received responsive to an input (e.g., responsive to an input by a site supervisor to a computing device such as the computing device 200, as described with respect to FIG. 2).

At 404, the method 400 can include extracting graphical elements from the building graphics data, as detailed herein. For instance, the method 400 can include extracting graphical elements by performing symbol detection using a computer vision algorithm trained to identify building asset symbols in the building graphics data, extraction of text from the building graphics data using optical character recognition, and identification of connections (e.g., lines) in the building graphics data, as detailed herein.

At 406, the method 400 can include generating a graph showing spatial relationships between building assets associated with the extracted graphical information, as detailed herein. For instance, the graph can include nodes representing the respective locations of various different building equipment and/or building equipment symbols, text, and linear connections (e.g., lines) in the received building graphics data.

At, 408, the method 400 can include generating contextual embeddings associated with the building assets in the graph, as detailed herein. At 410, the method 400 can include mapping the contextual embeddings associated with the building assets in the graph to a master database of standardized building assets, as detailed herein. At 412, the method can include generating a spatial asset map of the building assets based on the mapping, as detailed herein.

In some embodiments, the method 400 can include storing the spatial asset map. For instance, the spatial asset map can be stored in a database or other type of storage structure. For instance, the spatial asset map can be stored in a centralized platform, such as ENTERPRISE BUILDINGS INTEGRATOR™ and/or FORGE; available from HONEYWELL™, Inc. Similarly, in some embodiments, the master database can be stored in a database or other type of storage structure e.g., such as ENTERPRISE BUILDINGS INTEGRATOR™ and/or FORGE; available from HONEYWELL™, Inc.

In some embodiments, the method 400 can include displaying a representation of the spatial asset map, as described herein. In some embodiments, the method 400 can include receiving, via the computing device such as those described herein (e.g., a BMS computing device), a selection of one or more elements within the spatial asset map. For example, a selection of one or more building assets in the spatial asset map can thereby result in the automatic display of any associated information (e.g., performance information, notifications and/or warnings associated with the selected building assets), among other possible information associated with the spatial asset map.

Aspects of the illustrative methods herein can be performed with or via one or more of the components described herein. For instance, the illustrative methods herein can be performed in conjunction with or by at least a computing device (e.g., computing device 200), among other possible components.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for image-based spatial mapping of building assets in building management systems, the method comprising:
receiving building graphics data;
extracting graphical elements from the building graphics data by:
performing symbol detection using a computer vision algorithm trained to identify building asset symbols in the building graphics data;
extracting text from the building graphics data using optical character recognition;
identifying connections in the building graphics data; and
generating a graph showing spatial relationships between building assets associated with the extracted graphical information;
generating contextual embeddings associated with the building assets in the graph;
mapping the contextual embeddings associated with the building assets in the graph to a master database of standardized building assets; and
generating a spatial asset map of the building assets based on the mapping.

2. The method of claim 1, wherein generating a spatial asset map of the building assets based on the mapping further comprises determining for each contextual mapping whether a match exists in the master database of standardized building assets.

3. The method of claim 2, when a corresponding mapping exists in the master database for a contextual embedding of the contextual embeddings, using the mapping for the building asset in the spatial asset map.

4. The method of claim 2, when a corresponding mapping does not exist in the master database for an embedding of the contextual embeddings, automatically correcting non-standard text in the contextual embeddings using a similarity algorithm trained to determined similarities between non-standard text in the contextual embeddings and a standardized building asset in the master database.

5. The method of claim 4, further comprising automatically correcting the non-standard text in the contextual embedding using contextual cues, spatial relationships, or a combination thereof.

6. The method of claim 2, when a corresponding mapping does not exist in the master database for an embedding of the contextual embeddings:
prompting a user to update the master database with a new mapping for the embedding without a corresponding mapping; and
using the new mapping for the building asset in the spatial asset map.

7. The method of claim 6, further comprising storing the new mapping in the master database.

8. The method of claim 3, wherein the non-standard text in the contextual embedding includes a typo, a non-standard naming convention, an optical character recognition mistake, or any combination thereof.

9. The method of claim 1, wherein performing symbol detection further comprises:
acquiring and augmenting building graphics data;
annotating the data to identify asset symbols;
training a computer vision algorithm to yield the trained computer vision algorithm.

10. The method of claim 1, wherein the trained computer vision algorithm is a trained You Only Look Once (YOLO) detection model or is a trained convolutional neural network (CNN).

11. The method of claim 1, wherein extracting text information further comprises:
extracting text coordinates from the recognized text; and
associating the extracted text with detected building asset symbols based on spatial proximity between the extracted text and the detected symbols.

12. The method of claim 1, wherein identifying connections further comprises:
identifying horizontal and vertical lines in the building graphics data;
extracting coordinate information for the detected lines; and
linking the detected horizontal and vertical lines with identified building asset symbols to establish connections.

13. The method of claim 12, further comprising:
identifying start and end points of the horizontal and vertical lines; and
linking the start and end points of the horizontal and vertical lines to the identified building asset symbols to establish connection between the building asset symbols.

14. The method of claim 1, further comprising display the spatial asset map through a user interface to permit user interaction with one or more elements in the spatial asset map.

15. The method of claim 1, further comprising preprocessing the building graphics data, wherein the preprocessing includes changing a resolution of the building graphics data to a standard resolution.

16. A computing device for image-based spatial mapping of building assets in building management systems, the computing device comprising:
a display;
a memory; and
a processor configured to execute executable non-transitory computer readable instructions stored in the memory to:
receive building graphics data indicative of building asset locations within an industrial process;
extract graphical elements from the building graphics data by:
performing symbol detection using a computer vision algorithm trained to identify building asset symbols in the building graphics data;
extracting text from the building graphics data using optical character recognition;
identifying connections in the building graphics data; and
generate a graph showing spatial relationships between building assets associated with the extracted graphical information;
generate contextual embeddings associated with the building assets in the graph;
map the contextual embeddings associated with the building assets in the graph to a master database of standardized building assets;
generate a spatial asset map of the building assets based on the mapping; and
display the spatial asset map through a user interface.

17. The computing device of claim 16, wherein the building graphics data comprises building blueprints, architectural drawings, piping and instrument diagrams, or any combination thereof.

18. The computing device of claim 16, wherein the processor is further configured to preprocess the building graphics data, wherein the preprocessing includes changing a resolution of the building graphics data to a standard resolution.

19. A non-transitory, computer-readable medium including instructions that are executable a processor to:
receive building graphics data indicative of building asset locations within an industrial process, wherein the building graphics data comprises building blueprints, architectural drawings, piping and instrument diagrams, or any combination thereof;
extract graphical elements from the building graphics data by:
perform symbol detection using a computer vision algorithm trained to identify building asset symbols in the building graphics data;
extract text from the building graphics data using optical character recognition;
identify connections in the building graphics data; and
generate a graph showing spatial relationships between building assets associated with the extracted graphical information;
generate contextual embeddings associated with the building assets in the graph;
map the contextual embeddings associated with the building assets in the graph to a master database of standardized building assets;
generate a spatial asset map of the building assets based on the mapping; and
display the spatial asset map through a user interface.

20. The medium of claim 19, further comprising instructions executable by the processor to:
determine for each contextual mapping whether a match exists in the master database; and
i) when a corresponding mapping exists in the master database for a contextual embedding of the contextual embeddings, using the mapping for the building asset in the spatial asset map; or
ii) when a corresponding mapping does not exist in the master database for an embedding of the contextual embeddings:
prompt a user to update the master database with a new mapping for the embedding without a corresponding mapping;
use the new mapping for the building asset in the spatial asset map; and
store the new mapping in the master database.
